(19) United States
(12) Patent Application Publication
(10) Pub. No.: US 2008/0305072 A1
(43) Pub. Date: Dec. 11, 2008

(54) Attractant for the Anastrepha Obliqua Fruit Fly

(76) Inventors: Edi Malo Alvaro Rivera, Chiapas (MX); Julio Cesar Rojas Leon, Chiapas (MX); Leopoldo Caridad Cruz Lopez, Chiapas (MX); Jorge Toledo Arreola, Chiapas (MX)

Correspondence Address: HUNTON & WILLIAMS LLP;INTELLECTUAL PROPERTY DEPARTMENT, RIVERFRONT PLAZA, EAST TOWER, 951 EAST BYRD ST., RICHMOND, VA, 23219-4074, US

(21) Appl. No.: 11/913,960

(22) PCT Filed: May 9, 2006
(86) PCT No.: PCT/MX2006/000033

§ 371 Date: Mar. 31, 2008

(30) Foreign Application Priority Data
May 9, 2005 (MX) YU/A/2005/000008

(51) Int. Cl. A01N 31/00; A01P 19/00

(52) U.S. Cl. 424/84

(57) ABSTRACT

The invention relates to a specific attractant for male and female Anastrepha obliqua fruit flies. The inventive attractant comprises a mixture of identified, isolated synthetic compounds which have been formulated according to the proportions in which they were found in the Spondia mombin volatiles.

### FIELD OF THE INVENTION

The present invention is related to the development of a fruity attractant for detecting, monitoring and controlling the fruit fly Anastrepha obliqua. All the components of the attractant are commercially available.

### BACKGROUND OF THE INVENTION

Fruit flies from the family Tephritidae represent a major problem for fruit growing in general, due to the damage caused when in larval stage when feeding off the fruits and also because of the restrictions established by countries and international organizations on fruit commercialization. For instance, in Mexico, there are about 170,000 hectares of mango crops (Mangifera indica), with a production of 1.4 millions of tons, from which about 196,000 tons are for exportation. This crop is attacked mainly by Anastrepha oblique and Anastrepha ludens (Aluja et al., J. Econ. Entomol. 89:654-667, 1996). Also, these fly species attack other commercial fruits as well and are considered as species subject to quarantine in the US and Europe, which constitutes a limiting factor for fruit exportation to those countries' markets.

Traditionally, flies from genera Anastrepha are monitored using McPhail traps baited with liquid attractants such as protein hydrolyzate+borax as microbial inhibitor (López and Hernández-Becerril, J. Econ. Entomol. 60:136-140, 1967) and/or Torula yeast (López et al., Fla. Entomol. 64: 1541-1543, 1971). However, there are some disadvantages in using liquid attractants including low selectivity since they attract other insects besides fruit flies. The fact that some non-target insects are being captured in the traps increases the checking time of the same. On the other hand, during the change of attractant in the traps, some of the attractant may be spilled and the spilled bait becomes a food source for flies outside the trap, thereby decreasing the trap efficiency (Epsky et al., Fla. Entomol. 76: 626-635, 1993; Thomas et al., Fla. Entomol. 84: 344-351, 2001). The above-described disadvantages had led to seek out solid attractants from different sources including volatile substances produced by bacteria, feces and bird feathers (Demilo et al., J. Entomol. Sci. 32: 245-256, 1997; Epsky et al., Fla. Entomol. 80: 270-276, 1997; Robacker et al., Fla. Entomol. 81: 497-508, 1998; Robacker et al, J. Chem. EcoL., 26: 1849-1867, 2000). By example, ammonium salts and putrescine (1,4-diaminobutane) have been shown to be selective attractants both for males and females from Anastrepha ludens (U.S. Pat. Nos. 576,667 and 5,907,923). However, the catches using ammonium acetate, putrescine and trimethylamines depend on the season of the year (Heath et al., J. Econ. Entomol. 90: 1584-1589, 1997). In the draught season, traps baited with these compounds captured significantly less Anastrepha ludens than the traps baited with liquid protein. The opposite is seen in the rain season, when traps lured with ammonium acetate, putrescine and trimethylamines captured significantly more flies than traps lured with protein (Heath et al., J. Econ. Entomol. 90: 1584-1589, 1997). An attractant based on the combination of 2,5-dimethylpirazine with ammonium salts and putrescine resulted more effective in capturing Anastrepha obliqua than the combination of ammonium salts and putrescine (Patent GB 2356141).

Volatile compounds released by host fruits for fruit fly constitute other potential source of attractants. Volatiles from fruits could be used by fruit flies to locate food and ovoposition sources, and to find and mate a partner (Jang & Light, olfactory semiochemicals, pp. 73-90, in: Fruit fly pest, a world assessment of their biology and management, MacPheron, B. A. & G. J. Steck (eds), St. Lucie Press, Delray Beach, Fla., 1996). Regarding attractants obtained from native host for Anastrepha species, the most relevant work has been done with Anastrepha ludens (Robacker et al., J. Chem. EcoL., 16: 2799-2815, 1990; J. Chem. EcoL., 18: 1239-1254, 1992). These researchers have isolated and identified four volatile compounds attractive to Anastrepha ludens from fruits of its native host (Sargentia greggii). Compounds were identified as 1,8-cinneole, ethyl hexanoate, hexanol, and ethyl octanoate, which when formulated together resulted more attractive than Torula in laboratory trials. However, in filed trials, this volatiles formulation did not show a better performance than Torula yeast (Robacker & Heath 1996). Traps lured with ethanol extracts of Spondias purpurea captured more Anastrepha obliqua adults than traps lured with protein hydrolysate in a mango orchard (Ortega-Zaleta and Cabrera-Mireles, Agric. Téc. Méx 22: 63-75, 1996). None of the compounds was identified as responsible of the attractancy of the extracts.

Furthermore, the attractants that were found could be used for controlling fruit flies through the attraction-killing approach. With this approach, captured insects are killed by means of an insecticide, a pathogen agent, or an sterilant.

We have developed a specific attractant for detecting, monitoring and controlling males and females from the fruit fly A. obliqua using a mixture made up of synthetic compounds from a native fruit from Chiapas, Mexico, locally known as jobo de pava, Spondias mombin.

### DETAILED DESCRIPTION OF THE INVENTION

Next, the extraction, electroantennographic detection, chemical identification, formulation and assessment of the attractant for both adult males and females from fruit fly Anastrepha obliqua are described.

Evaluation of Biological Activity of Jobo Fruit in Attracting Anastrepha obliqua

Firstly, an experiment was developed to evaluate whether the Anastrepha obliqua adults are attracted to the jobo fruit using a flight tunnel under laboratory conditions (Rojas et al., Entomología Mexicana, Vol. 2, 690-694, 2004). Treatments were evaluated in non-choice trials. One ripe fruit from Spondias mombin was used for each repeat, which was placed inside the tunnel in the opposite end from an air extractor at a height of 15 cm above the floor. An orange colored styrofoam sphere mimicking the color of the fruit (artificial fruit) was used as control. For each repeat, 25 males or females were released into the tunnel and observed for 10 min. Two parameters were recorded: attraction and landing. Attraction is defined as ⅔ the distance traveled by the flies from the point of release to the sample. Landing involves that the insect steps on the fruit. Results from the bioassays demonstrated that both females and males were more attracted to the jobo fruits than to the control. Both sexes also landed more frequently on the jobo fruits than on the artificial fruit.

Collecting and Evaluation of Biologically Activity of Volatiles from Jobo de Pava Fuit

The next step is to collect volatile compounds released by the jobo the pava fruit and to evaluate the extracts activity. Healthy ripe fruits and infection-free from flies or others insects were directly obtained from trees located in the vicinity of Tapachula, Chiapas, Mexico. The volatile compounds were collected using the dynamic aeration technique (Malo et al., Entomología Mexicana, Vol. 3, 115-118, 2003). Volatiles were trapped using 1 g of the adsorbent Porapak Q, and 16 hours after collecting, volatiles were eluted from the adsorbent using 200 μl of anhydrous ether.

Extracts were evaluated in the flight tunnel, in the following manner: 100 μl of the extract were loaded in a rubber septum, previously washed with hexane. The septum was placed on an artificial fruit. As control an artificial fruit impregnated with 100 μl of anhydrous ether was used. Results from this test show that males and females were more attracted to the jobo's volatiles extracts than to control. Both sexes also landed more frequently on the artificial fruit lured with the extract than on the artificial fruit lured with solvent alone.

Gas Chromatography-Electroantennography (GC-EAD) Analysis of Anastrepha obliqua to Jobo de Pava's Volatiles

The following step is to determine the chemical compound(s) responsible for the attractancy and landing of the insect. To this, a technique known as gas chromatography coupled to electroantennography (Arn et al., Z. Naturforsch. 30 C: 722-725, 1975) was used. The advantage of this technique is that it includes the high sensitivity of the insect antennae, whereby only the compounds showing electrophysiological activity are identified. A minimum of 16 different antennae from males and females were used. During the analysis by GC-EAD 9 antennally active peaks were found, both in males and females of Anastrepha obliqua.

Chemical Identification

Once that the antennally active compounds were determined, the chemical identification of said compounds were performed using a gas chromatography unit coupled to a mass spectrometer, according to a previously described procedure (Malo et al., Entomología Mexicana, Vol. 3, 115-118, 2003; Rojas et al., Entomología Mexicana, Vol. 2, 690-694, 2004). Identifications were confirmed comparing both retention times and spectra data to authentic standards obtained from commercial sources. Compounds were identified as esters and alcohols.

Attractant Evaluation in the Lab

Once that the compounds were identified the making of the mixture of synthetic compounds, and its evaluation in the flight tunnel took place. In this test 1 μl of the blend of the nine synthetic compounds, made according to the ratio in which they were found in the jobo extracts, was used. The compounds blend was loaded into a rubber septum. The septum was placed onto the artificial fruit. An artificial fruit having a septum loaded with 1 μl of hexane was used as control. Results indicated that both sexes were significantly more attracted towards the mixture of the nine components than to control. Males and females landed more frequently onto the artificial fruit lured with the mixture of the nine components that in the control fruits.

Evaluation of the Attractant in Field Cages

Finally, we proceed to evaluate the attraction of the synthetic mixture of the components comparing it versus the protein hydrolysate and water as control in non-choice and triple choice trials in field cages. The tests were performed in field cages of 2.85 m in diameter by 2 m high. In non-choice trials one coffee tree (Coffea arabica) and one mango tree (Mangifera indica) of 1.20 meters high were placed centrally inside the cage. In triple choice trials, 5 coffee trees and 6 mango trees were placed inside the cage, one tree from each species in each of the cardinal points and two trees (one in the case of coffee) in the center of the cage. In non-choice trials one Multilure trap was placed 50 cm above the tree. In triple choice trials, 3 Multilure traps were placed at 30 cm in the periphery of the cage, with a separation of about 185 cm between each trap. Traps were hung at 10 cm from the cage. The mixture of synthetic compounds was prepared according to the ratio in which they were found in the jobo's volatiles extracts, and 100 mg of this mixture were loaded in rubber septa. Protein hydrolysate Captor 300 was prepared using 5 g of borax mixed with 10 ml of protein hydrolysate dissolved in 235 ml of water per trap. Water plus Tween 80 were used to keep the flies captured in traps lured with jobo's volatiles and water. Twenty five (12 or 13 of each sex, in non-choice trials) and 150 flies (75 of each sex, in triple choice trials) subjected to a 15 hours fasten were released in the center of the cage during the early hours of the morning. Baits were placed in each trap 15 minutes before flies were released in the cage. Traps were placed at 08:00 a.m. and the number of captured insects in each trap was counted 24 hrs later. The position of each trap was re-distributed on a daily basis to avoid any effect due to position. In the trials, temperature fluctuated from 23-31° C. and relative humidity fluctuated from 60 to 95%. Each experiment was repeated 12 times.

Results from the field tests show that traps lured with the mixture of jobo's synthetic volatiles captured significantly more Anastrepha obliqua than the traps lured with protein hydrolysate and than the control.

What is claimed is:

1. A constituted blend of esters and alcohols which general formula is (A+B+C+D+E+F+G+H+I) that generates attracting activity on both males and females of Anastrepha obliqua.

2. The blend of claim 1, wherein in the general formula A is ethyl butyrate.

3. The blend of claim 2, wherein in the general formula B is isopropyl butyrate.

4. The blend of claim 3, wherein in the general formula C is hexanol.

5. The blend of claim 4, wherein in the general formula D is propyl butyrate.

6. The blend of claim 5, wherein in the general formula E is isobutyl butyrate.

7. The blend of claim 6, wherein in the general formula F is ethyl hexanoate.

8. The blend of claim 7, wherein in the general formula G is ethyl butyrate.

9. The blend of claim 8, wherein in the general formula H is ethyl benzoate.

10. The blend of claim 9, wherein in the general formula I is ethyl octanoate.

11. The blend of claim 10, wherein the ethyl butyrate is present from about 30 to 40% in the composition of claim 1.

12. The blend of claim 11, wherein the isopropyl butyrate is present from about 0.5 to 1.2% in the composition of claim 1.

13. The blend of claim 12, wherein the hexanol is present from about 0.5 to 1.2% in the composition of claim 1.

14. The blend of claim 13, wherein the propyl butyrate is present from about 1 to 1.6% in the composition of claim 1.

15. The blend of claim 14, wherein the isobutyl butyrate is present from about 3 to 5% in the composition of claim 1.

16. The blend of claim 15, wherein the ethyl hexanoate is present from about 30 to 40% in the composition of claim 1.

17. The blend of claim 16, wherein the ethyl butyrate is present from about 3 to 4.5% in the composition of claim 1.

18. The blend of claim 17, wherein the ethyl benzoate is present from about 10 to 15% in the composition of claim 1.

19. The blend of claim 18, wherein the ethyl octanoate is present from about 3 to 5% in the composition of claim 1.

20. The blend of claim 10, wherein the ethyl butyrate is present in the composition in 36.8%, isopropyl butyrate in 0.8%; hexanol in 0.8%; propyl butyrate in 1.3%; isobutyl butyrate in 3.6%; ethyl hexanoate in 36.7%; isopentyl butyrate in 3.8%; ethyl benzoate in 12.6% and ethyl octanoate in 3.6%.

21. The blend of claim 10, wherein the ethyl butyrate is present in the composition in 36.8%, isopropyl butyrate in 0.8%; hexanol in 0.8%; propyl butyrate in 1.3%; isobutyl butyrate in 3.6%; ethyl hexanoate in 36.7%; isopentyl butyrate in 3.8%; ethyl benzoate in 12.6% and ethyl octanoate in 2.5%.

22. The blend of claim 10, wherein the ethyl butyrate is present in the composition in 36.8%, isopropyl butyrate in 0.8%; hexanol in 0.8%; propyl butyrate in 1.3%; isobutyl butyrate in 3.6%; ethyl hexanoate in 36.7%; isopentyl butyrate in 3.8%; ethyl benzoate in 12.6% and ethyl octanoate in 1.5%.
